(19) United States
(12) Patent Application Publication
(10) Pub. No.: US 2003/0235417 A1
(43) Pub. Date: Dec. 25, 2003

(54) Method for evaluating fixing member and fixing belt and thermal fixing roller

(76) Inventors: Norihiko Aze, Tokyo (JP); Kyoichi Ashikawa, Tokyo (JP); Kohji Kamiya, Tokyo (JP); Minoru Matsuo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/394,227

(22) Filed: Mar. 24, 2003

(30) Foreign Application Priority Data
Mar. 22, 2002 (JP) 2002-81741

(51) Int. Cl. G01M 19/00

(52) U.S. Cl. 399/31; 73/865.9; 73/81

(57) ABSTRACT

A test measurement of the universal hardness is carried for a fixing belt (20) formed by sequentially coating an elastic layer (22) and a separation layer onto a base element (21), in which case, the universal hardness is determined for each of indentation depths of 1 μm and 4 μm from the surface side of the separation layer (23). The fixing belt (20) can be regarded as a standard product, when the universal hardness HU for the indentation depth of 1 μm satisfies the relation, HU≦30 [N/mm²], and, at the same time, when the universal hardness HU for the indentation depth of 4 μm satisfies the relation, HU≦12 [N/mm²].

### BACKGROUND OF THE INVENTION

1. Field of the Invention

The present invention relates to a method for evaluating a fixing member, more specifically, to a method for evaluating a fixing belt and/or a thermal fixing roller used in an electrophotographic apparatus or the like are evaluated, and also relates to such a fixing belt and such a thermal fixing roller.

2. Description of the Prior Art

FIG. 18 is a schematic sectional drawing for explaining the image forming process in an electrophotographic apparatus. The schematic drawing represents a process of forming a monochromatic image. However, in the process of forming a full color image, developing units for four different colors, i.e., red (magenta), blue (cyan), yellow (yellow) and black (black) as well as a mechanism for mixing or superimposing the four color images are employed.

In FIG. 18, such an electrophotographic apparatus (for instance, a copy machine or a laser printer) is equipped with a rotary photoconductor drum 1. A photosensitive layer on the photoconductor drum 1 is uniformly charged by an electrostatic charging unit 2, and then exposed by a laser beam 3 emitted from a laser-scanning unit. Thereby, an electrostatic latent image is formed on the photoconductor drum 1. The electrostatic latent image which is formed on the photoconductor drum 1 is developed by toner in a developing apparatus 4, and then a toner image is produced. Subsequently, the toner image on the photoconductor drum 1 is transferred to a copy paper or a recording paper 6 with the aid of a transfer roller 5. In FIG. 18, furthermore, reference numerals 7, 8 and 9 means a power supply unit (power pack), a surface electrometer and a cleaning unit, respectively.

In the following, a thermal fixing apparatus used for thermally fixing the toner image transferred onto the recording paper 6, will be described. Traditionally, it is known that a roller-type thermal fixing apparatus 10, as shown at the upper left in FIG. 18, is used to thermally fix toner for a monochromatic image (only black toner). Such a thermal fixing apparatus 10 is equipped with a thermal fixing roller 11 and a press roller 12 which are disposed in parallel to each other in order to put or sandwich a recording paper 6 between the thermal fixing roller 11 and the press roller 12.

The thermal fixing roller 11 includes a hollow cylindrical core body made of aluminum or the like, and an adhesion-preventing layer for preventing toner from adhering is coated onto the outer circumferential surface of the core body, where the layer is made of fluorocarbon resin or the like. Moreover, heaters as halogen lamps or the like (not shown) are disposed parallel to the center line of the hollow space inside the core body of the thermal fixing roller 11, thereby enabling the roller main body to be heated from the inside thereof by the radiation emitted from the heater. The movement of the recording paper 6 between the thermal fixing roller 11 and the press roller 12 causes the toner on the recording paper 6 to be softened (molten) due to the heat from the thermal fixing roller 11, so that the toner is fixed onto the recoding paper 6 with the aid of the press roller 12.

The above-described thermal fixing roller having a fluorocarbon resin layer is excellent as for the toner separation ability, but it is inferior as for both the flexibility and elasticity, so that such a fixing roller is not suitable for using in the full color copying machine and/or the full color laser printer, which requires a glossy printing surface. As a result, four types of color toner are conventionally used in the full color copying machine or the full color laser printer. When, however, four types of color toners are used, these color toners have to be mixed in the molten state to fix the color image, as described in Japanese Patent Application Laid-open Publication No. 10-198201. For this purpose, the toners themselves must be prepared such that they are fusible at a lower melting temperature, and that several color toners must be uniformly mixed in the state in which the toners are wrapped on the surface of the thermal fixing roller. In this case, lack of both the flexibility and the elasticity for the surface of the thermal fixing roller makes it difficult to uniformly mix the several different types of color toner. In other words, it is of particularly importance that the surface of the thermal fixing roller should have appropriate flexibility and elasticity.

On the other hand, it is also known that a belt type thermal fixing apparatus 15, as shown at the lower left in FIG. 18, may be employed. In the thermal fixing apparatus 15, a layer-shaped fixing belt 18 is wound between a fixing roller 16 and a heating roller 17, and further a press roller 19 is disposed in parallel to the fixing roller 16. In this arrangement, the heating roller 17 heats the fixing belt 18, and then a recoding paper 6 passes through a contact surface between the fixing roller 16 and the press roller 19. The recording paper 6 is heated in the course of the passage, so that a toner image is transferred onto the recording paper 6 and then fixed thereon.

The above-mentioned fixing belt has a gummy elastic layer made of a silicone gum, fluorocarbon gum or the like on the surface. Such an elastic layer provides an excellent flexibility and elasticity. However, it lacks of the toner separation ability, so that the toner-offset phenomenon often occurs.

In recent years, taking these facts into account, a fixing belt and a thermal fixing roller have been proposed, which are formed by coating a gummy elastic layer on a base element and further by coating a toner separation material of fluorocarbon resin or the like on the elastic layer.

However, the fixing belt or the thermal fixing roller in the prior art, in which such a separation layer made of a fluorocarbon resin is coated onto the gummy elastic layer, causes important properties required for the surface of the fixing belt and the thermal fixing roller, i.e., the flexibility and the elasticity, to be deteriorated.

The fixation of toner with a fixing belt or a thermal fixing roller having inadequate flexibility and elasticity provides either a matt pattern in an image (unevenness in the image intensity) or an opaque pattern in an image on an OHP sheet.

Such a problem no longer arises, if it may be ascertained with ease whether or not a fixing belt or a thermal fixing roller has an appropriate flexibility and elasticity. Unfortunately, there is no conventional method for synthetically evaluating the hardness of the separation layer, taking into account the influence of the base element and the elastic layer thereon.

### SUMMARY OF THE INVENTION

Accordingly, it is an object of the present invention to provide a method for evaluating a fixing member, in which excellence in the toner separation ability, the flexibility and elasticity can be easily evaluated, and it is another object of the present invention to provide a fixing belt and a thermal fixing roller which have an excellent toner separation ability, flexibility and elasticity.

In order to attain the above mentioned objects, a first feature of the present invention is to evaluate a fixing member used to fix toner, said fixing member being produced by sequentially coating an elastic layer and a separation layer onto a base element, in such a way that the universal hardness test is carried out for each of indentation depths of 1 μm and 4 μm from the surface side of the separation layer, when the universal hardness HU for the indentation depth of 1 μm satisfies a relation, HU≦30 [N/mm²], and, at the same time, when the universal hardness HU for the indentation depth of 4 μm satisfies a relation, HU≦12 [N/mm²], the fixing member is regarded as a standard product.

The present inventors intensively carried out investigations on the fixation of toner images developed on a paper, an OHP film or the like without unevenness in the image intensity. A close examination of the obtained results reveals that the surface hardness of a fixing member can be optimally evaluated, utilizing the universal hardness HU, which is specified in the German Industrial Standard, DIN 50359-1 (this standard is capable of describing the properties of materials in a much more detailed manner). In fact, by measuring the universal hardness HU for each of indentation depths of 1 μm and 4 μm from the surface side of the separation layer, for example, if the relation HU≦30 [N/mm²] is satisfied for the indentation depth of 1 μm and, at the same time, if the relation HU≦12 [N/mm²] is satisfied for the indentation depth of 4 μm, the fixing member can be regarded as a standard product.

The above-mentioned universal hardness test is carried out at a test environment temperature of 25° C.

The universal hardness test can also be carried out at a test environment temperature of 200° C. Hence, a second feature of the present invention is to evaluate a fixing member used to fix toner, said fixing member being produced by sequentially coating an elastic layer and a separation layer onto a base element, in such a way that the universal hardness test is carried out at a test environment temperature of 200° C. for each of indentation depths of 1 μm and 4 μm from the surface side of said separation layer, when the universal hardness HU for the indentation depth of 1 μm satisfies a relation, HU≦10 [N/mm²], and, at the same time, when the universal hardness HU for the indentation depth of 4 μm satisfies a relation, HU≦4 [N/mm²], the fixing member is regarded as a standard product.

In the first and second features of the present invention, the elastic layer is made of silicon gum.

Furthermore, in the first and second features of the present invention, the separation layer is made of a material including at least one of polytetrafluoroethylene (PTFE) resin, polytetrafluoroethylene-perfluoro-alkoxyl (PFA) vinyl ether copolymer resin and polytetrafluoroethylene-fluorinated ethylene propylene (FEP) copolymer resin.

Moreover, in the first and second features of the present invention, the fixing member is either a fixing belt or a thermal fixing roller.

In a third feature of the present invention, a fixing belt is formed by sequentially coating an elastic layer and a separation layer onto a base element, and, when the measurement is carried out at a test environment temperature of 25° C., the universal hardness HU for an indentation depth of 1 μm from the surface side of the separation layer satisfies the relation, HU≦30 [N/mm²], and, at the same time, the universal hardness HU for an indentation depth of 4 μm satisfies the relation, HU≦12 [N/mm²].

In a fourth feature of the present invention, a fixing belt formed by sequentially coating an elastic layer and a separation layer onto a base element is provided, wherein when the measurement is carried out at a test environment temperature of 200° C., the universal hardness HU for an indentation depth of 1 μm from the surface side of the separation layer satisfies the relation, HU≦10 [N/mm²], and, at the same time, the universal hardness HU for an indentation depth of 4 μm satisfies the relation, HU≦4 [N/mm²].

In the third and fourth features of the present invention, the elastic layer is made of silicone gum.

Moreover, in the third and fourth features of the present invention, the separation layer is made of a material including at least one of polytetrafluoroethylene (PTFE) resin, polytetrafluoroethylene-perfluoro-alkoxyl (PFA) vinyl ether copolymer resin and polytetrafluoroethylene-fluorinated ethylene propylene (FEP) copolymer resin.

Moreover, the above-mentioned fixing belt can be employed in a thermal fixing apparatus and/or an image forming apparatus.

In a fifth feature of the present invention, a thermal fixing roller is formed by sequentially coating an elastic layer and a separation layer onto a base element, when the measurement is carried out at a test environment temperature of 25° C., the universal hardness HU for an indentation depth of 1 μm from the surface side of the separation layer satisfies the relation, HU≦30 [N/mm²], and, at the same time, the universal hardness HU for an indentation depth of 4 μm satisfies the relation, HU≦12 [N/mm²].

In a sixth feature of the present invention, a thermal fixing roller is formed by sequentially coating an elastic layer and a separation layer onto a base element, when the measurement is carried out at a test environment temperature of 200° C., the universal hardness HU for an indentation depth of 1 μm from the surface side of the separation layer satisfies the relation, HU≦10 [N/mm²], and, at the same time, the universal hardness HU for an indentation depth of 4 μm satisfies the relation, HU≦4 [N/mm²].

In the fifth and sixth features of the present invention, the elastic layer is made of silicone gum.

Moreover, in the fifth and sixth features of the present invention, the separation layer is made of a material including at least one of polytetrafluoroethylene (PTFE) resin, polytetrafluoroethylene-perfluoro-alkoxyl (PFA) vinyl ether copolymer resin and polytetrafluoroethylene-fluorinated ethylene propylene (FEP) copolymer resin.

Moreover, the above-mentioned thermal fixing roller can be employed in a thermal fixing apparatus and/or an image forming apparatus.

In accordance with the present invention, excellence with regard to the toner separation ability, the flexibility and elasticity can be easily evaluated and, therefore, a high quality image having no unevenness in the image intensity can be obtained by mounting a selected fixing member having high quality in a thermal fixing apparatus and an image forming apparatus.

Moreover, a fixing belt and/or a fixing roller having excellent toner separation ability, flexibility and elasticity can be realized.

Since, moreover, silicon gum is used for the elastic layer, a smooth surface having evenness in the layer thickness can be obtained.

Since, moreover, the separation layer includes at least one of PTFE, PFA, FEP, a sufficient toner separation ability as well as a sufficient durability can be obtained.

### BRIEF DESCRIPTION OF THE DRAWINGS

FIG. 1(a) is a sectional view of a fixing belt according to the present invention;

FIG. 1(b) is an enlarged sectional view of an area A in FIG. 1(a);

FIG. 2 is a schematic sectional view of a fixing belt for explaining the mechanism in which toner is fixed on a recording paper;

FIG. 3(a) is a schematic sectional view of a thermal fixing apparatus in an embodiment;

FIG. 3(b) is a schematic sectional view of a thermal fixing apparatus in another embodiment;

FIG. 4 is a diagram showing the relationship between the universal hardness and the rank of matt pattern;

FIG. 5 is a diagram showing the relationship between the universal hardness and the rank of matt pattern;

FIG. 6 is a diagram showing the relationship between the universal hardness and the rank of matt pattern;

FIG. 7 is a diagram showing the relationship between the universal hardness and the rank of matt pattern;

FIG. 8 depicts diagrams showing the relationship between the universal hardness and the test environment temperature: (a) indentation depth=1 μm; (b) indentation depth=4 μm; and (c) indentation depth=20 μm;

FIG. 9 is a diagram showing the relationship between the universal hardness and the test environment temperature at varied indentation depths, where the universal hardness is determined by averaging the data in FIG. 8;

FIG. 10 is a diagram showing the relationship between the universal hardness and the indentation depth;

FIG. 11 is a diagram showing the relationship between the universal hardness and the indentation depth;

FIG. 12 is a diagram showing the relationship between the universal hardness and the rank of matt pattern;

FIG. 13 is a diagram showing the relationship between the universal hardness and the rank of matt pattern;

FIG. 14 is a diagram showing the relationship between the universal hardness and the rank of matt pattern;

FIG. 15 is a diagram showing the relationship between the universal hardness and the rank of matt pattern;

FIG. 16 is a diagram showing the relationship between the universal hardness and the rank of matt pattern;

FIG. 17 is a diagram showing the relationship between the universal hardness and the rank of matt pattern; and

FIG. 18 is a schematic sectional view of an image forming apparatus.

### DESCRIPTION OF THE PREFERRED EMBODIMENTS

Referring now to the accompanying drawings, several embodiments of the present invention will be described below.

FIG. 1 shows a fixing belt 20 according to the invention; the section of the fixing belt 20 and an enlarged sectional view of the section A are represented in FIG. 1(a) and FIG. 1(b), respectively. As shown in FIG. 1, the fixing belt 20 comprises a cylindrical base element 21, an elastic layer 22 coated on the base element 21 and a separation layer 23 coated on the elastic layer 22.

The base element 21 is made of a heat resistant material. Such a heat resistant material is a metal material, such as stainless steel SUS, nickel or the like, or a heat resistant resin, such as polyimide, polyamide-imide, fluorocarbon resin or the like. In the case of such a metal material, it is preferable that the layer thickness of the base element 21 should be less than 100 μm, taking the bending of the belt into account. In the case of such a heat resistant resin, it is preferable that the layer thickness of the base element 21 should be 30 to 200 μm from the viewpoint of the heat capacity (a smaller thickness is more advantageous due to the reduction in the standby time) and the mechanical strength (a greater thickness is more advantageous thereto).

The elastic layer 22 is used to obtain the evenness and uniformity in a glossy image, and a flexible surface of the belt may be obtained by coating the elastic layer 22. In order to ensure the heat resistance at a relatively high temperature (less than 200° C.), in the case of fixing, a silicone gum is used as a material for the elastic layer 22, and its thickness should be preferably 200 μm or so.

The material for the separation layer 23 may be selected from fluorocarbon resin, such as polytetrafluoroethylene (PTFE) resin, polytetrafluoroethylene-perfluoro-alkoxyl (PFA) vinyl ether copolymer resin, polytetrafluoroethylene-fluorinated ethylene propylene (FEP) copolymer resin or the like, or a mixture of these resins, or a heat resistant resin in which such a fluorocarbon resin is dispersed. The thickness of the separation layer 23 should be preferably 20 μm or so.

The covering of the elastic layer 22 with the separation layer 23 provides a good toner separation ability and also prevents powder from adhering to a recording paper even if silicone oil or the like is not used (the oil-less approach). Generally, the above-mentioned resin having a good toner separation ability has no such elasticity as in gum materials, so that there is a danger that unevenness appears on the glossy surface of the recording paper, when separation layer 23 having a relatively large thickness is coated on the elastic layer 22. In other words, the separation layer 23 has to be coated on the elastic layer 22 without any reduction in the flexibility thereof in order to consistently ensure both the suppression of the unevenness in the glossy surface of the recording paper and the separation ability of the toner and/or the paper powder. Accordingly, it is preferable that the material for the separation layer 23 should be as flexible as possible and that the thickness thereof should be as thin as possible.

As described above, the requirements as for the fixing belt having three layers of the base element 21, the elastic layer 22 and the separation layer 23 resides in the rationalization of the surface state and the numerical characterization of the belt. The surface of the belt comes into contact with an unfixed toner image and serves transferring a heat to the toner therein, so that the fixing of the toner image onto the recording paper is carried out by pressing the belt onto the paper. When, however, the surface of the belt is uneven, the state of contact is different from the top area to the bottom area of the belts. Of course, such a difference in the contact provides a marked difference in the heat transfer and in the pressure applied to the toner, thereby causing unevenness to being generated in the glossy surface of the recording paper. The elastic layer 22 serves reducing or moderating the difference in the contact state at the top and bottom areas with the aid of its elasticity.

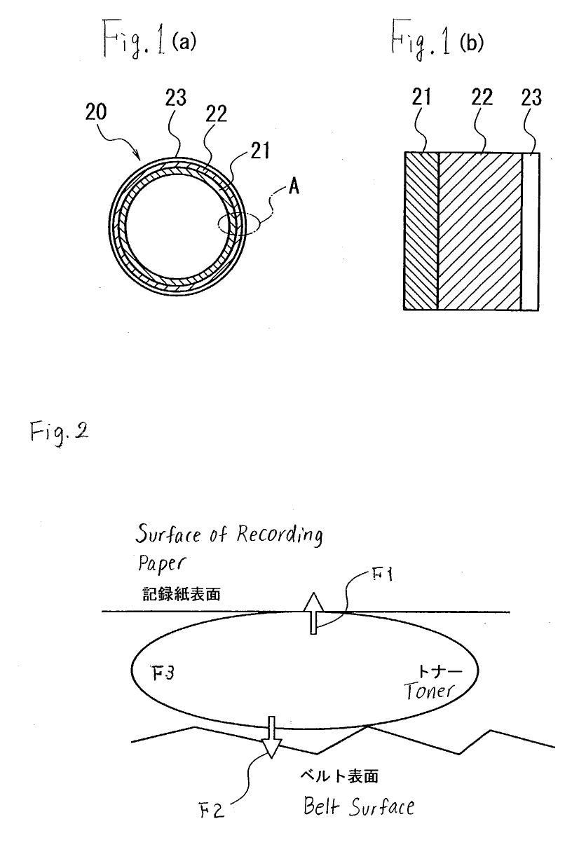

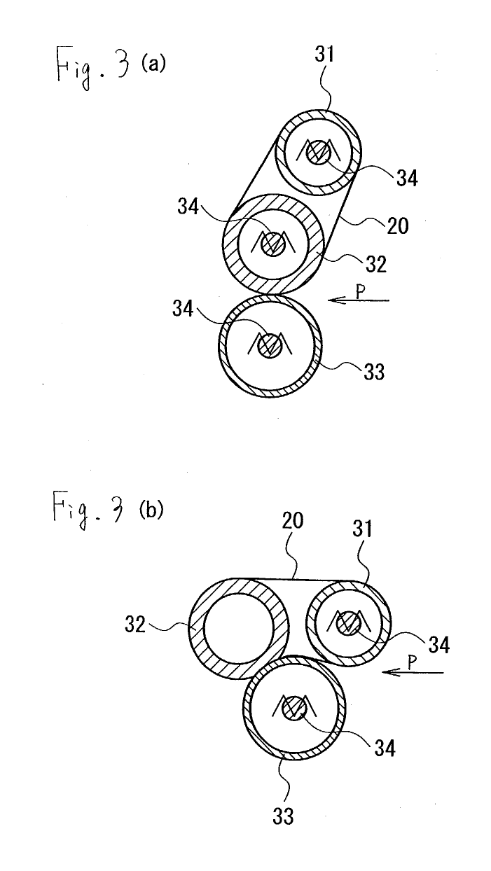

Referring to FIG. 2, the influence of the surface state of the belt on the uniformity in an image as well as the fixing characteristic will subsequently be described. In FIG. 2, symbols F1, F2 and F3 mean an adhesive force between the recording paper and the toner, an adhesive force between the belt and the toner and a cohesive force of the toner, respectively.

Firstly, regarding the uniformity in the image, it is assumed that the unevenness in the glossy surface (image) results from the difference in the state of contact between the toner and the convex or concave areas (the top or bottom areas) of the surface of the belt. When the fixing roller and the press roller are pressed against each other, the top area is flattened due to the elasticity of the belt surface. In this case, the degree of flatness depends on the magnitude of the elasticity as well as the shape of the belt surface. When the material is the same in varied areas on the belt surface, it depends on only the shape of the belt surface. A decrease in the number of top areas having a smaller height causes the deviation in the contact state to be reduced due to the unevenness. In conjunction with this, unevenness in the glossy surface (image) (i.e., unevenness in the brilliance) can be seen as a matt surface, so that it is referred to as a matt pattern or surface.

Secondly, the fixing characteristic (the separation ability) will be described. The fixing characteristic used herein means the separation ability (the fixing temperature difference=the hot offset temperature−the cold offset temperature). In other words, the fixing characteristic indicates how the fixing temperature difference is changed by the state of the belt surface. Generally, the cold offset implies the state in which the toner is not sufficiently fixed on the recording paper. This results from the incomplete fusion of the toner (due to a smaller fixing temperature) and the incomplete press force between the belt and the recording paper.

The surface roughness is one of factors for evaluating the state of the belt surface. As a characteristic value, the mean roughness Ra determined by averaging the roughness along the center line, the mean roughness Rz determined by averaging the roughness over ten points or the like is generally used. When either Ra or Rz becomes large, both the magnitude of heat transfer to the toner and the press force decrease at the bottom areas, thereby causing the cold offset to be induced with an increasing probability.

The hot offset is a phenomenon in which molten toner is adhered to the belt surface and remains thereon. The phenomenon takes place when the adhesion force F2 between the belt and the toner is greater than the cohesive force F3 of the toner itself. When the material is the same in the varied areas of the belt surface, an increase in the area of the contact surface with the toner provides an increase in the adhesion force F2 between the belt and the toner.

In the following, a method for numerically characterizing the surface hardness according to the present invention will be described.

As for the surface hardness regarded as another important factor for evaluating the surface property, it is difficult to find the correlation between the surface hardness and the important image property in the full color fixing apparatus, i.e., the latter being the evenness in the glossy surface (image) and the image transparency of an OHP sheet, as described in the survey of the prior art, and therefore it is difficult to obtain a reproducible image quality.

In view of these facts, the present inventors investigated the correlation between the hardness of the belt surface and the image quality by utilizing the universal hardness HU defined in the German Industrial Standard DIN 50359-1. The results of the investigation revealed a marked correlation between “the amount of HU for a specified indentation depth from the surface” and “the evenness in the glossy surface (image) (matt pattern)”.

The universal hardness HU used herein will be described:

Traditionally, the surface hardness in a micro surface area has been determined with a micro Vickers hardness test method or the like, in which an indentation probe is pressed onto the surface of a material to be tested and then the indentation depth of the indentation probe from the surface is measured under an optical microscope after the load is released. On the contrary, in the method for measuring the universal hardness HU, the hardness is determined by directly reading the indentation depth in the state of applying a weight to the indentation probe. In this case, the indentation depth is measured for the weight having not only one value but also varied values by stepwise increasing the weight, so that varied indentation depths are determined for the individual test weights. This method makes it possible to determine the hardness for a micro surface area of an elastic body, on the surface of which the trace of the indentation can hardly be retained and to determine the hardness of a heterogeneous surface layer.

However, the following two points have to be taken into account in the actual measurement:

The thickness of a test piece should be more than ten times greater than the indentation depth.

The indentation depth should be more than twenty times greater than the surface roughness Ra of a surface of the test piece, when the measurement is carried out with an uncertainty of less than 10%.

The surface roughness Ra of a usual fixing member is 0.1-0.2 μm. In this case, therefore, the indentation depth have to be set greater than 2-4 μm. However, it is possible to reduce the minimum value of the indentation depth by applying a smoothed treatment such as polishing or the like, on the surface of the fixing member.

The universal hardness HU can be obtained from the following equation:

$$\begin{matrix}HU = F / S \\ = F / 26.43 {h}^{2} [ N \text{/} {mm}^{2} ]\end{matrix}$$

where F: the test load [N],

S: the surface area of the indentation probe under the test load [mm²] and

H: the indentation depth under the test load [mm],

and the indentation probe is a quadrangular pyramid-shaped diamond indentation probe (Vickers indentation probe) having an angle of 136° between the facing surfaces.

In the present embodiment, the universal hardness test is carried out for each of indentation depths of 1 μm and 4 μm from the surface side of the separation layer 23 at a test environment temperature of 25° C., and the fixing member can be regarded as a standard or utility product, when the following two conditions are satisfied: The universal hardness HU at the indentation depth of 1 μm is HU≦30 [N/mm²] and the universal hardness HU at the indentation depth of 4 μm is HU≦12 [N/mm²].

In the present embodiment, moreover, the universal hardness test is carried out for each of indentation depths of 1 μm and 4 μm from the surface side of the separation layer 23 at a test environment temperature of 200° C., and the fixing member can be regarded as a standard product or an utility product, when the following two conditions are satisfied: The universal hardness HU at the indentation depth of 1 μm is HU≦10 [N/mm²], and the universal hardness HU at the indentation depth of 4 μm is HU≦4 [N/mm²].

In the present embodiment, the evaluation of the hardness for the fixing belt is exclusively described. However, the present invention can also be applied to a thermal fixing roller, in which an elastic layer and a separation layer are laminated on a core body, i.e., a base element.

In conjunction with the above, an investigation regarding the influence of the universal hardness on the image quality was carried out.

An unfixed image was formed on a recording paper and then fixed on the recording paper under the following conditions, using a thermal fixing apparatus. In this case, using fixing belts whose surface having different values in the universal hardness, the relationship between the universal hardness and the matt image (the unevenness in the glossy surface) after fixing was investigated.

Image to be evaluated (unfixed image),

Toner: magenta color,

Amount of deposition: 0.8-0.9 mg/cm², and

Type of paper: T 6200 (62 kg paper).

In the following, a full color thermal fixing apparatus including the fixing belt according to the present embodiment will be described. A fixing belt 20 as shown in FIG. 3 is used in the thermal fixing apparatus. The fixing belt 20 is wound in an appropriate tension between a heating roller 31 and a fixing roller 32 (the mechanism for applying the tension is not shown). Moreover, a press roller 33 is disposed in parallel to the fixing roller 32, and further the fixing belt 20 wound around the fixing roller 32 is pressed against the side of the fixing roller 32 so as to come into contact therewith by the press roller 33 (the press contact mechanism is not shown).

Generally, there are two types of the press contact method for pressing the fixing belt 20 by the press roller 33, as shown in FIG. 3(a) and FIG. 3(b). In the method of FIG. 3(a) (RICOH Co. Ltd.: Imagio color (registered Trade Mark) 3100 or the like), a nip section comprising only a press roller 33 and a fixing roller 32 (along with a fixing belt interposed therebetween) is employed. However, in the method of FIG. 3(b) (RICOH Co. Ltd.: Ipsio color (registered Trade Mark) 8000 or the like), not only a nip section comprising a press roller 33 and a fixing roller 32, but also another nip section, in which the fixing belt 20 puts between the press roller 33 and a heating roller 31, is employed. Such a difference in the structural arrangement practically provides a difference between the two methods as for the standby time, the transportation ability, the sheet-separation ability and others. Since, however, the properties of a fixing belt itself were exclusively studied in the present embodiment, the influence of the belt on the image quality was investigated only for the fixing method as shown in FIG. 3(a).

In FIG. 3, halogen lamps 34 are mounted in the inside of the heating roller 31 to heat the same. The number and the power consumption of the halogen lamps 34 are adjusted in accordance with the specification (the standards) regarding the fixing temperature, the line speed, the standby time and the surface temperature variation on the belt surface. Generally, halogen lamps 34 are mounted in the inside of each of the heating roller 31, the fixing roller 32 and the press roller 33 in the arrangement of FIG. 3(a), whereas the halogen lamps 34 are mounted in the inside of each of the heating roller 31 and the press roller 33 in the arrangement of FIG. 3(b). In FIG. 3, arrow P indicates the direction of feeding the recording paper.

The following test conditions are employed:

Fixing test machine: Improved fixing unit in the Imagio color 3100,

Fixing roller: 40 mmφ, silicone gum elastic layer 5 mm+FLC 30 μm, gum hardness 62.5 Hs (Asker C),

Press roller: 40 mmφ, silicone gum elastic layer 2 mm+PFA tube 50 μm, gum hardness 72 Hs (Asker C),

Nip pressure: 45 kgf on one side,

Line speed: 200 mm/s,

Universal hardness test machine: Fischer scope H-100

Test load: 0.4 mN-1000 mN (≈300 mN in this test)

Regarding to the evaluation of matt image, the following ranks of evaluation are used (for the rank halfway between the ranks, 0.5 is added to the lower rank):

Rank 5: no significant unevenness in the matt image standard level.

Rank 4: between rank 3 and rank 5 standard level.

Rank 3: unevenness partially generated in matt image standard level.

Rank 2: between rank 1 and rank 3 impermissible level.

Rank 1: unevenness generated over the entire mat image impermissible level.

### EXAMPLE 1

Generally, it is known that a matt image becomes prominent in a highly glossy image. Using a kind of toner (toner No. 1) providing a glossiness of 5-8% (magenta color: 0.8-0.9 mg/cm²) at a fixing temperature of 160-170° C. as well as another kind of toner (toner No. 2) providing a glossiness of 10-15% (magenta color: 0.8-0.9 mg/cm²) at the same fixing temperature under the above-mentioned conditions, the relationship between the universal hardness and the glossiness of the image was studied for varied degrees of gloss in the image.

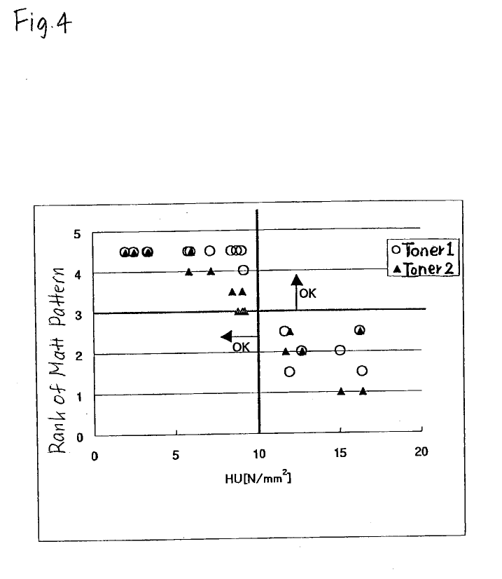

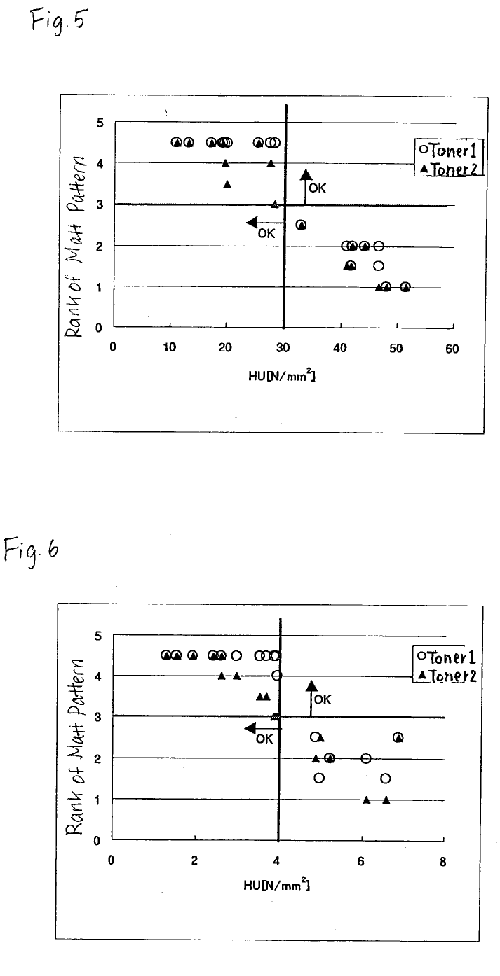

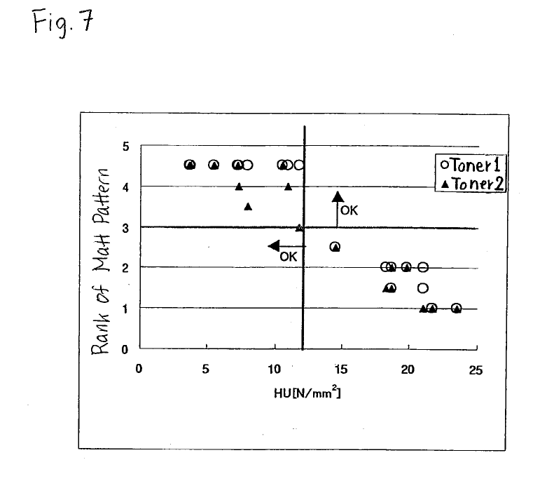

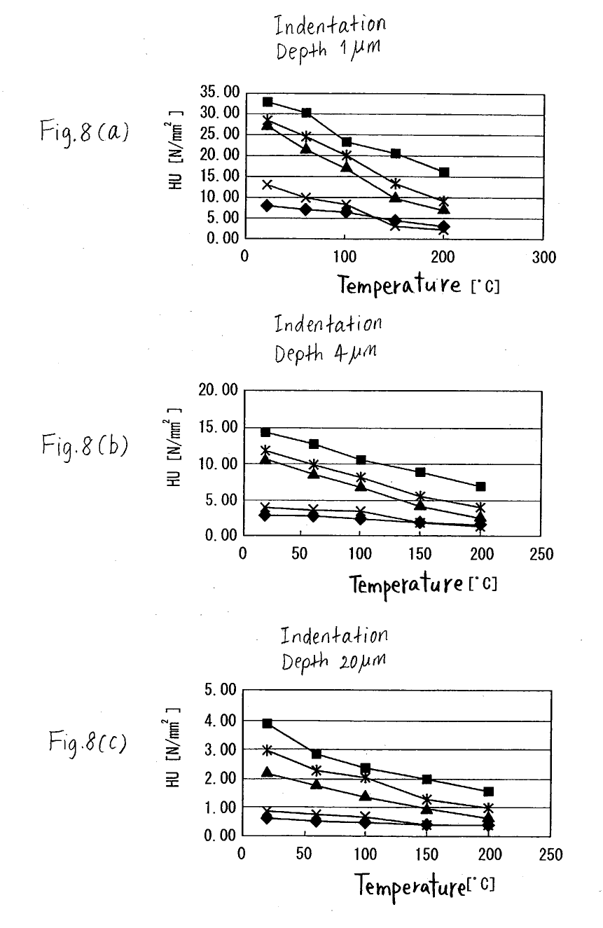

FIGS. 4 to 7 show the obtained results of the relationship between the universal hardness and the rank of matt pattern, in which case, FIG. 4 shows the data for an indentation depth of 1 μm at a test environment temperature of 200° C.; FIG. 5 shows the data for an indentation depth of 1 μm at a test environment temperature of 25° C.; FIG. 6 shows the data for an indentation depth of 4 μm at a test environment of 200° C.; and FIG. 7 shows the data for an indentation depth of 4 μm at a test environment temperature of 25° C. From the data, it can be recognized that an excellent uniformity in the gloss (rank of more than 3) can be obtained, when the following equations (1)-(4) are satisfied:

HU1≦30 [N/mm²], (1)

and

HU2≦12 [N/mm²], (2)

where HU1 and HU2 are magnitudes of universal hardness for the indentation depths of 1 and 4 μm from the surface of the separation layer at the test environment temperature of 25° C., respectively.

HU3≦10 [N/mm²], (3)

and

HU4≦4 [N/mm²], (4)

where HU3 and HU4 are magnitudes of universal hardness for the indentation depths of 1 and 4 μm from the surface of the separation layer at the test environment temperature of 200° C., respectively.

From the results for equations (1)-(4), the universal hardness can be estimated for an arbitrary indentation depth within a range of 1 μm-4 μm at a test environment temperature of 25° C. or 200° C. Similarly, the universal hardness can be estimated at an arbitrary test environment temperature (except for the temperature greater than the resin decomposing temperature), when the indentation depth is set 1 μm or 4 μm.

In the following, the reason why 1 μm or 4 μm should be selected as the indentation depth will be described. As described in the survey of the prior art, no explicit numerical characterization has been given for the hardness of the belt (elements) and the evenness in the gloss. In particular, it is not clear whether the evenness in the gloss results from the flexibility of the entire belt including the bending of the base element or the flexibility of the outermost surface, i.e., extremely restricted depth area of the fixing belt. In the measurement of the hardness of the outermost surface, the indentation depth should be set less than 1 μm, because there is a minimum thickness of 10 μm or so in the separation layer and also there is the above-described restriction on the layer thickness in the measurement. If the belt can be regarded as a laminated structure (base element+elastic layer+separation layer), the measurement can be carried out for a greater indentation depth. When, for example, the base element having a 50 μm thickness, the elastic layer having a 200 μm thickness and the separation layer having a 30 μm thickness are employed, the total layer thickness becomes 280 μm and, therefore, the measurement can be carried out for an indentation depth of not more than 28 μm. The present inventors experimentally confirmed a marked relationship between the universal hardness and the evenness in the gloss for an indentation depth of 1-20 μm.

Regarding the indentation depth, there is no special meaning for adopting either 1 μm or 4 μm. For instance, an indentation depth of 2 μm or 3 μm interposing between these values can also be adopted, and a similar correlation between the universal hardness and the evenness in the gloss can be obtained. In this case, the relationship between the hardness and the evenness in the gloss can be obtained within the range shown in the present embodiment, if the measurement is carried out for the belt (elements) at each of indentation depths of 1 μm and 4 μm.

Furthermore, the reason why 25° C. or 200° C. should be employed as the test environment temperature will be described. In accordance with the German Industry Standard DIN 50359-1, the specified measurement temperature is 10-35° C. In view of this fact, the measurement temperature of 25° C. was adopted in the present embodiment. The Fischer scope H-100 used in the present measurement was capable of varying the measurement temperature, so that the measurement was carried out at an environment temperature of 200° C. near the fixing temperature, and the relationship between the hardness and the evenness in the gloss was investigated.

From the results in FIGS. 4 to 7, it can be recognized that the toner No. 1 has a greater magnitude of allowance for the matt image than the toner No. 2. In other words, an increased glossiness in an image provides an increased unevenness in the gloss (matt pattern). This means that, in order to obtain a high glossy image, the toner should be fixed onto a recording paper after sufficiently fusing the toner to reduce the viscosity thereof, and the toner having such low viscosity should be pressed onto the surface of an element having a greater magnitude of flexibility.

In the following, the influence of the structural arrangement of the fixing belt on the universal hardness was investigated. In this case, the universal hardness, the durability and the toner separation ability were studied for fixing belts having various kinds of material in varied thickness of the elastic layer and the separation layer (experimental examples 1-5 and comparative examples 1-7), as shown in Table 1. The results are also shown in Table 1.

The structural arrangement of the belts is as follows:

Base element: Polyimide resin; 60 mmφ; the surface length, 331 mm; layer thickness, 90 μm.

Elastic layer: Silicone gum; hardness, 25° (JIS K 6301); layer thickness; Two level (non, 200 μm).

Separation layer: material of Three level; PFA No. 1 (a reduced flexibility), PFA No. 2 (an increased flexibility), FEP; layer thickness, 10-40 μm.

In the following, the method for producing the fixing belt will be described. A blade coating method was employed to form the elastic layer (after diluting the resin with a solvent, a spray coating method, a dipping coating method or the like can also be employed). In the present embodiments, silicone gum was used as a material for the elastic layer, and it is known that the silicone gum has an excellent heat resistance, because its upper usable temperature in the continuous operation is 200° C. As described above, fluoro-silicone gum, fluorocarbon gum or the like can also be used as a gummy (elastomer) material used for the elastic layer. At present, however, only the fluoro-silicone gum is usable in various coating processes, such as the spray coating, the dipping coating, blade coating, molding or the like. In conjunction with this, the fluoro-silicone gum is most preferable with respect to the cost. As a result, it was found that the silicone gum is currently most preferable as a material for the elastic layer, when a layer having a thickness of 200 μm or so is coated with a small thickness scattering as well as with a greater surface smoothness.

The spray coating method was employed to form the separation layer. Moreover, it is noted that a primer can be sandwiched or interposed between the polyimide base element and the elastic layer as well as between the elastic layer and the separation layer, as the necessity arises, and then the primer provides no significant effect on the properties of the fixing belt.

From the results in Table 1, it is found that the values of the universal hardness required for obtaining the above-mentioned evenness in the glossy image are not satisfied in the comparative examples 1-4, in which no elastic layer is interposed between the base element and the separation layer.

It is further found that an increase in the thickness of the separation layer causes the value of the universal hardness to be increased (hardened) in the case of interposing the elastic layer. The principle of determining the universal hardness has already been described in the above explanation. When this measuring method is applied to the material to be measured in the present invention, in which case, the material comprises the resins and gummy materials, it follows that “the apparent indentation depth measured by an indentation probe”=“the actually indented depth of the probe onto the surface”+“the depth corresponding to the bending of the surface”.

When, therefore, a separation layer is formed on an elastic layer, a decrease in the thickness of the separation layer causes the flexibility of the elastic layer to be enhanced on the belt surface (the surface of the separation layer), so long as the hardness of the elastic layer<the hardness of the separation layer (it is assumed that this condition generally holds). That is, “the depth corresponding to the bending of the surface” increases and, therefore, it can be recognized that the value of the universal hardness becomes apparently small.

The material PFA No. 1 is less flexible than the material PFA No. 2. Such a difference in the elasticity (flexibility) of the fluorocarbon resin will be explained. The material used for the separation layer is generally selected from such fluorocarbon resins, in which case, the hardness depends on the difference in the type of the resin; FEP, PFA, PTFE or the like, the difference in the molecular weight, the existence/non-existence of a filler, the coating method and/or the like. The hardness is dependent on the grade as for the difference in the type and generally increases with the increase of the molecular weight. Moreover, the hardness is influenced not only by the type of polymer but also the addition of filler.

As a filler, carbon black, whisker, silica, silicon carbide, mica or the like can be used for enhancing the wear resistance, and furthermore carbon black, metal oxide or the like is used for providing the electrical conductivity. The addition of such a filler generally allows the material to be hardened.

As shown in Table 1, the universal hardness becomes different from the material to material used for the separation layer, when the same structural arrangement (the same layer thickness) is employed. The material PFA No. 1 provides a more restricted allowance for the matt image at an increased layer thickness, compared with the material PFA No. 2. From the results of the present test, it can be recognized that, in order to transfer the elasticity of the elastic layer to the separation layer, the thickness of the separation layer should be specified in accordance with the type of the material used for the separation, taking its flexibility into account.

In the comparative example 7, the fixing belt includes a directly exposed elastic layer (silicone gum) without any separation layer and the surface thereof exhibits an extremely small amount of the universal hardness. Nevertheless, the fixing belt is insufficient regarding both the durability and the separation ability. In fact, regarding the durability, the damage resulting from the contact area with a thermistor and/or the edges of a continuously passing recording paper on the surface of the silicone gum appears in the initial stage of evaluation. Regarding the separation ability, the fixable temperature difference between the cold offset and the hot offset is small, in particular for a thin type paper (45 kg paper) used as the recording paper, when a separation layer made of the fluorocarbon resin is employed. It can be stated, therefore, that a separation layer should be formed on the elastic layer.

In order to avoid inconvenience or problem in the matt image (especially in the case of a highly glossy image), it is indispensable to provide an appropriate flexibility to the fixing belt. For this purpose, it is effective to use the universal hardness as a characterization value for evaluating the flexibility. The universal hardness of the surface of the fixing belt depends on the type of the material for the elastic layer and the thickness thereof as well as the type of the material for the separation layer and the thickness thereof. An appropriate combination of these parameters makes it possible to satisfy the conditions for the universal hardness defined by the equations (1) to (4), thereby enabling an evenness to be obtained in the gloss (image).

However, as is also seen from the comparative example 7 in Table 1, the exposure of the gum material from the belt surface causes a practical inconvenience to be generated with regard to both the durability and the separation ability, and therefore it is necessary to apply a separation layer made of PTFE, PFA, FEP or a mixture thereof onto the surface of the elastic layer.

If a fluorocarbon resin having a very high flexibility is successfully developed, the structural arrangement without the elastic layer, i.e., the base element+the separation layer is capable of providing the universal hardness within the above-mentioned range. At the present stage, however, it appears that such a triple layer structure as the base element+the elastic layer+the separation layer satisfies all of the requirements as for the evenness in the gloss (image), the toner separation ability and the durability.

### EXAMPLE 2

In the following, using fixing belts in which the type of material and the layer thickness as for both the elastic layer and the separation layer are varied (experimental examples 6 to 10), the universal hardness test was carried out for indentation depths of 1 μm, 4 μm and 20 μm at test environment temperatures of 25° C., 60° C., 100° C., 150° C. and 200° C. The test results are summarized in Table 2.

In the experimental examples 6 to 10, the material and the layer thickness of the fixing belts are as follows:

### EXPERIMENTAL EXAMPLE 6

Elastic layer: Silicone gum; hardness 25° (JIS K 6301); layer thickness 200 μm,

Separation layer: Type of material, A; layer thickness 15 μm.

### EXPERIMENTAL EXAMPLE 7

Elastic layer: Silicone gum, hardness 25° (JIS K 6301), layer thickness 200 μm,

Separation layer: Type of material, B; layer thickness 30 μm.

### EXPERIMENTAL EXAMPLE 8

Elastic layer: Silicone gum; hardness 25° (JIS K 6301); layer thickness 200 μm,

Separation layer: Type of material, C; layer thickness 30 μm.

### EXPERIMENTAL EXAMPLE 9

Elastic layer: Silicone gum; hardness 25° (JIS K 6301); layer thickness 300 μm,

Separation layer: Type of material, C; layer thickness 10 μm.

### EXPERIMENTAL EXAMPLE 10

Elastic layer: Silicone gum; hardness 25° (JIS K 6301); layer thickness 200 μm,

Separation layer: Type of material, D; layer thickness 20 μm.

In the above, each of the types A to D of material uses a fluorocarbon resin including at least one of PTFE, PFA and FEP as basic ingredient. Mechanical strength of the fluorocarbon, such as hardness, elongation or is changed by a kind, a molecular weight and a formed method of the fluorocarbon resin. It is possible to enhance the hardness of fluorocarbon resin by adding a filler such as carbon black, graphite, and mica therein. Each of the types A to D represents the separation layer in which factors influenced the hardness of the layer. Concretely, the type A is a mixture of PTFE/PFA, the type B is a material added carbon black in PFA, the type C is a low molecular weight material, for example, PFA and the type D is a high molecular weight material, for example, PFA.

In Table 2, the following data are listed: (a) data for an indentation depth of 1 μm; (b) data for an indentation depth of 4 μm; (c) data for an indentation depth of 20 μm and (d) data averaged over the values of hardness for the indentation depths of 1 μm, 4 μm and 20 μm.

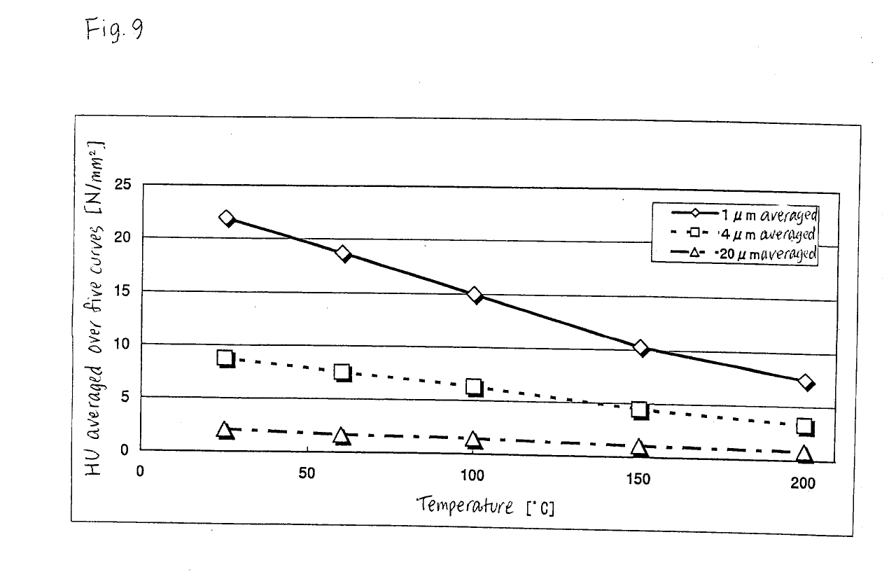

In addition, the data in Table 2 provide diagrams in FIG. 8, where the abscissa is the test environment temperature and the coordinate is the universal hardness. In FIG. 8, diagram (a) is the data for the indentation depth of 1 μm; diagram (b) is the data for the indentation depth of 4 μm; and diagram (c) is the data for the indentation depth of 20 μm. FIG. 9 is the diagram obtained by averaging the data at each of the indentation depths of 1 μm, 4 μm and 20 μm.

From the diagrams in FIGS. 8 and 9, it can be recognized that an increase in the test environment temperature causes the universal hardness to be decreased, and in particular, such a trend becomes more prominent in the indentation depth of 1 μm.

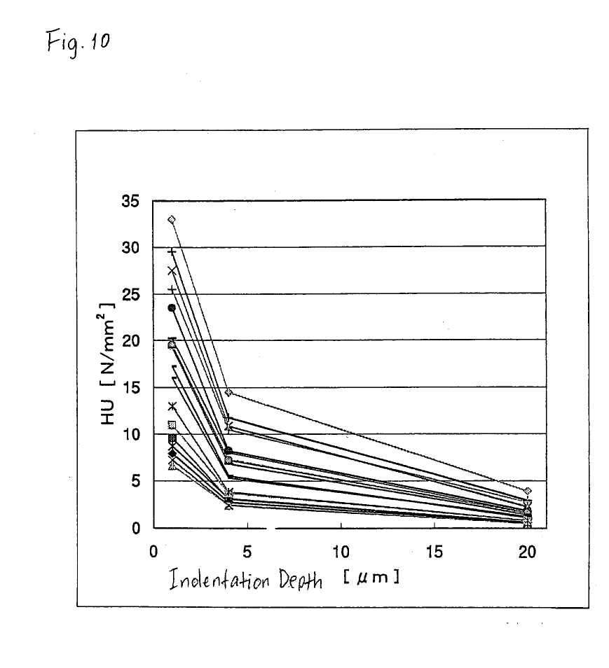

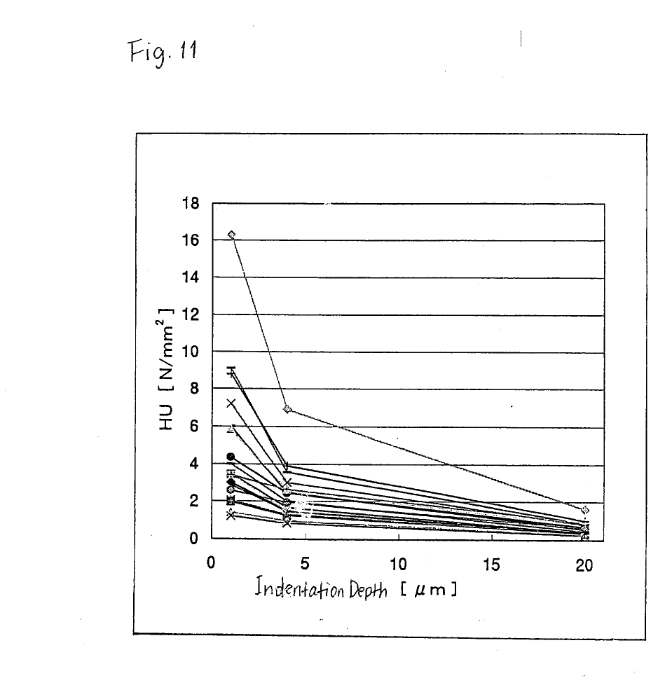

Furthermore, providing 12 fixing belts other than the fixing belts used in the experimental examples 6 to 10, the universal hardness test for each of these fixing belts was carried out at test environment temperatures of 25° C. and 200° C. and for indentation depths of 1 μm, 4 μm and 20 μm. The results of this test are shown in FIG. 10 and FIG. 11, along with those in examples 6 to 10. In the diagrams of FIGS. 10 and 11, the abscissa and the coordinate mean the indentation depth and the universal hardness, respectively. FIG. 10 depicts a diagram of experimental results at the test environment temperature of 25° C. and FIG. 11 depicts a diagram of experimental results at the test environment temperature of 200° C.

From the diagrams in FIG. 10 and FIG. 11, it can be recognized that, for the indentation depth from 1 μm to 4 μm, the flexibility and the elasticity of both the separation layer and the elastic layer contributes to the universal hardness and therefore an increase in the indentation depth causes the universal hardness to be drastically decreased, whereas for the indentation depth of greater than 4 μm, the contribution mainly results from the base element, thereby causing the universal hardness to be not largely decreased.

In view of these facts, it can be stated that the universal hardness test should be carried out within a range of indentation depths 1 μm to 4 μm in order to accurately measure the surface hardness of the fixing belt (or the thermal fixing roller).

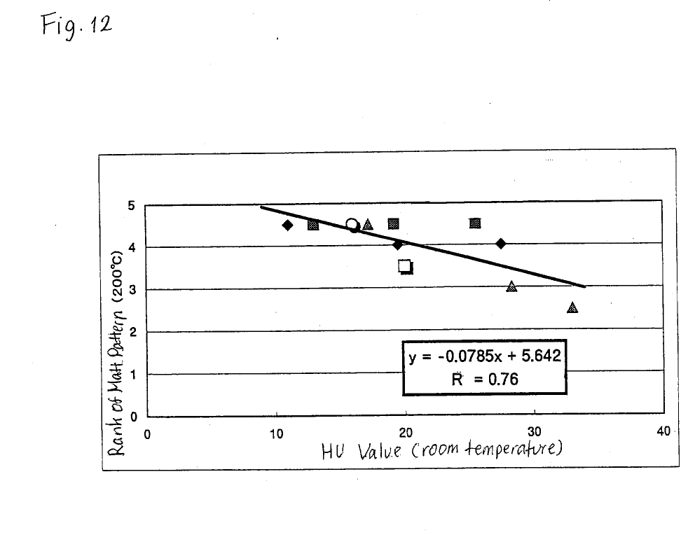

The above-mentioned data in the experimental examples are represented in FIG. 12 to FIG. 17, similarly to FIG. 4 to FIG. 7; in which case, the abscissa and the coordinate mean the universal hardness and the rank of matt pattern, respectively. In FIG. 12 to FIG. 17, the relationship between the universal hardness and the rank of matt pattern is represented by a linear equation which is determined by the least squares method, and further correlation coefficient is also determined therefrom. FIG. 12-FIG. 17 show the results obtained in the case of using the toner No. 2.

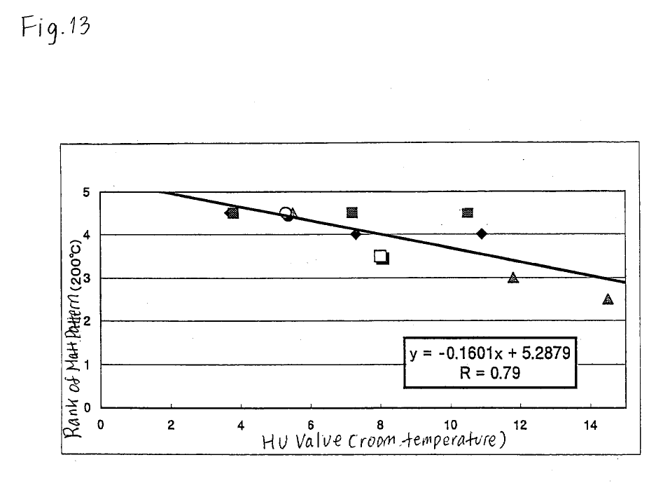

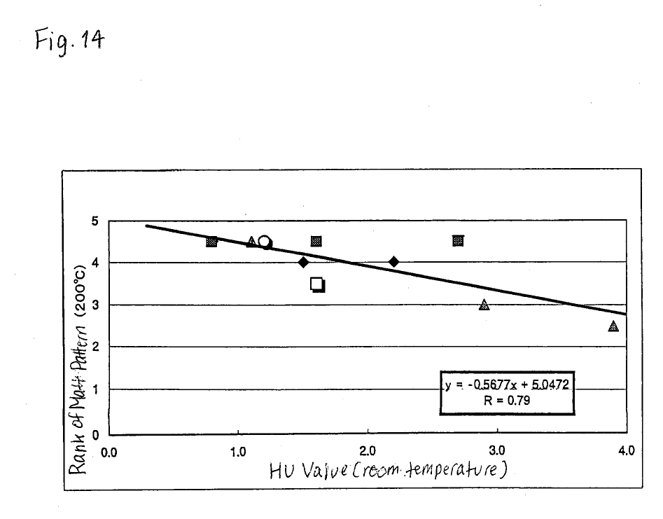

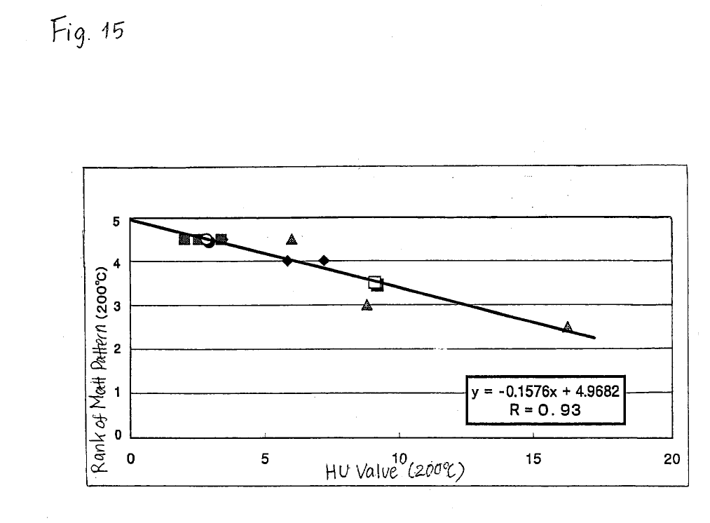

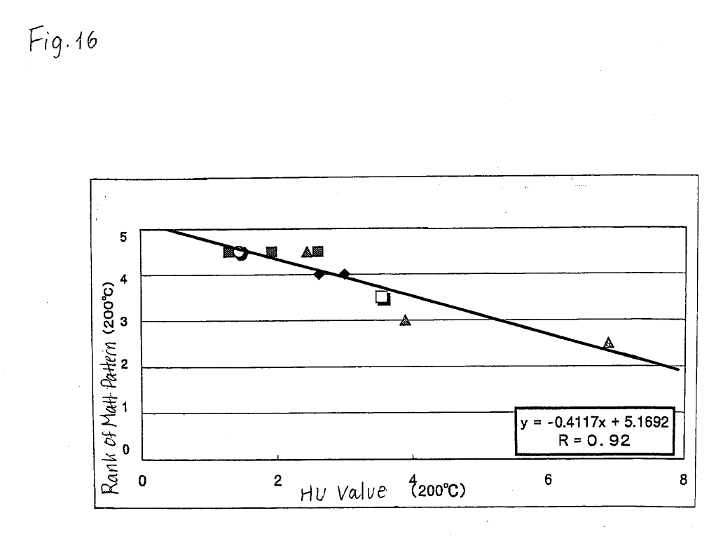

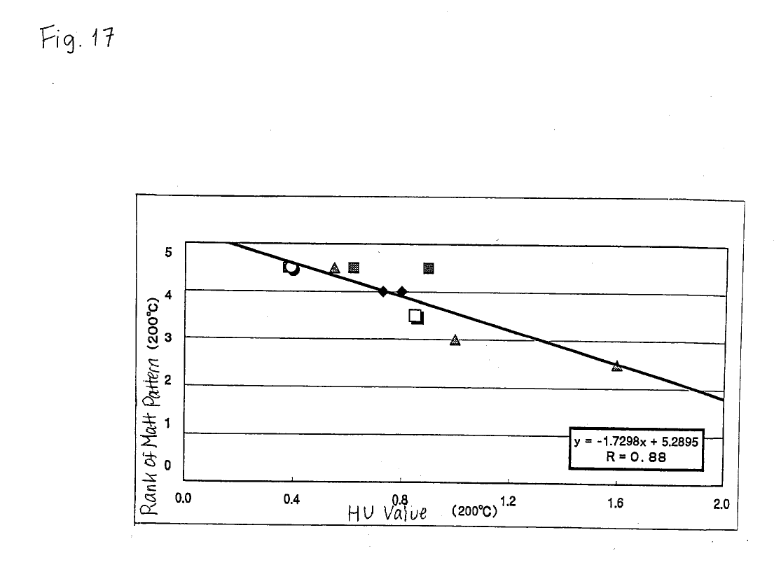

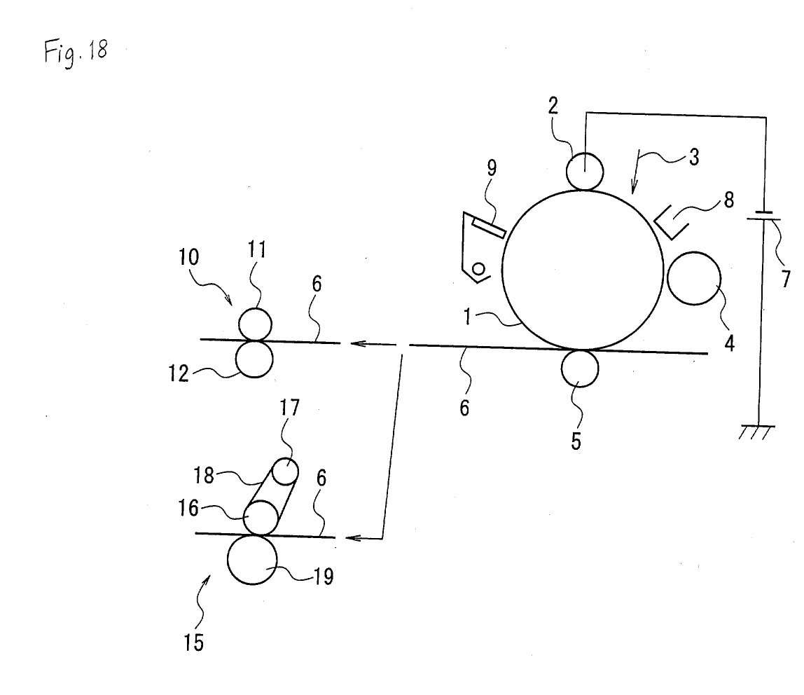

FIG. 12 shows the result obtained for an indentation depth of 1 μm at room temperature; FIG. 13 shows the result obtained for an indentation depth of 4 μm at room temperature; FIG. 14 shows the result obtained for an indentation depth of 20 μm at room temperature; FIG. 15 shows the result obtained for an indentation depth of 1 μm at a test environment temperature of 200° C.; FIG. 16 shows the result obtained for an indentation depth of 4 μm at a test environment temperature of 200° C.; and FIG. 17 shows the result obtained for an indentation depth of 20 μm at a test environment temperature of 200° C. The correlation coefficients determined from the diagrams in FIGS. 12 to 17 are listed in Table 3.

Table 3(a) shows the data at the test environment temperature of 200° C. and Table 3(b) shows the data at room temperature.

TABLE 1

| | | | Elastic | | | Universal Hardness | | | |
|---|---|---|---|---|---|---|---|---|---|
| | Separation Layer | | Layer | Universal Hardness (25° C., | | (200° C., Environment) | | | |
| | | Layer | Layer | Environment) [N/mm²] | | [N/mm²] | | | |
| | | Thickness | Thickness | Indentation | Indentation | Indentation | Indentation | | Separation |
| | Material | [82 m] | [μm] | Depth 1 μm | Depth 4 μm | Depth 1 μm | Depth 4 μm | Durability | Ability |
| Comparative | PFA1 | 20 | No Data | 48.0 | 21.7 | 15.1 | 6.1 | ◯ | ◯ |
| Example 1 | | | | | | | | | |
| Comparative | PFA2 | 10 | No Data | 46.7 | 21.1 | 12.0 | 5.0 | ◯ | ◯ |
| Example 2 | | | | | | | | | |
| Comparative | PFA2 | 20 | No Data | 41.1 | 18.2 | 9.1 | 3.9 | ◯ | ◯ |
| Example 3 | | | | | | | | | |
| Comparative | FEP | 20 | No Data | 46.7 | 21.1 | 9.2 | 4.0 | Δ | ◯ |
| Example 4 | | | | | | | | | |
| Experimental | PFA1 | 10 | 200 | 17.2 | 5.5 | 6.0 | 2.5 | ◯ | ◯ |
| Example 1 | | | | | | | | | |
| Experimental | PFA1 | 20 | 200 | 20.0 | 6.0 | 9.1 | 3.6 | ◯ | ◯ |
| Example 2 | | | | | | | | | |
| Comparative | PFA1 | 30 | 200 | 33.0 | 14.5 | 16.3 | 6.9 | 603 | 603 |
| Example 5 | | | | | | | | | |
| Experimental | PFA2 | 10 | 200 | 11.0 | 3.7 | 3.5 | 1.5 | ◯ | ◯ |
| Example 3 | | | | | | | | | |
| Experimental | PFA2 | 20 | 200 | 19.5 | 7.3 | 5.9 | 2.6 | ◯ | ◯ |
| Example 4 | | | | | | | | | |
| Experimental | PFA2 | 30 | 200 | 27.5 | 10.9 | 7.2 | 3.0 | ◯ | ◯ |
| Example 5 | | | | | | | | | |
| Comparative | PFA2 | 40 | 200 | 35.5 | 14.4 | 8.0 | 3.2 | ◯ | ◯ |
| Example 6 | | | | | | | | | |
| Comparative | . | . | 200 | 0.2 | 0.2 | 0.1 | 0.1 | X | X |
| Example 7 | | | | | | | | | |

TABLE 2

| | Temperature | | | | |
|---|---|---|---|---|---|
| | 25° C. | 60° C. | 100° C. | 150° C. | 200° C. |
| | 20 | 60 | 100 | 150 | 200 |
| (a) Indentation Depth 1 μm | | | | | |
| Experimental Example 6 | 7.90 | 7.00 | 6.20 | 4.40 | 3.00 |
| Experimental Example 7 | 33.00 | 30.30 | 23.20 | 20.50 | 16.30 |
| Experimental Example 8 | 27.50 | 21.70 | 17.70 | 9.90 | 7.20 |
| Experimental Example 9 | 13.00 | 10.00 | 7.95 | 3.20 | 2.03 |
| Experimental Example 10 | 28.30 | 24.50 | 20.00 | 13.50 | 8.80 |
| Averaged | 21.94 | 18.70 | 15.01 | 10.30 | 7.47 |
| (σ) | 10.85 | 9.87 | 7.53 | 7.07 | 5.69 |
| (b) Indentation Depth 4 μm | | | | | |
| Experimental Example 6 | 2.72 | 2.52 | 2.32 | 1.85 | 1.45 |
| Experimental Example 7 | 14.50 | 12.80 | 10.50 | 8.80 | 6.90 |
| Experimental Example 8 | 10.90 | 8.90 | 7.00 | 4.30 | 3.00 |
| Experimental Example 9 | 3.80 | 3.50 | 3.40 | 1.80 | 1.30 |
| Experimental Example 10 | 11.80 | 9.80 | 8.20 | 5.50 | 3.90 |
| Averaged | 8.74 | 7.50 | 6.28 | 4.45 | 3.31 |
| (σ) | 5.19 | 4.36 | 3.39 | 2.91 | 2.28 |
| (c) Indentation Depth 20 μm | | | | | |
| Experimental Example 6 | 0.60 | 0.51 | 0.49 | 0.39 | 0.35 |
| Experimental Example 7 | 3.90 | 2.80 | 2.30 | 2.00 | 1.60 |
| Experimental Example 8 | 2.20 | 1.80 | 1.50 | 1.00 | 0.80 |
| Experimental Example 9 | 0.79 | 0.71 | 0.69 | 0.41 | 0.38 |
| Experimental Example 10 | 2.90 | 2.30 | 2.10 | 1.30 | 1.00 |
| Averaged | 2.08 | 1.62 | 1.42 | 1.02 | 0.83 |
| (σ) | 1.40 | 0.99 | 0.81 | 0.67 | 0.51 |
| | 25° C. | 60° C. | 100° C. | 150° C. | 200° C. |
| | 25 | 60 | 100 | 150 | 200 |
| (d) Indentation Depth / Temperature | | | | | |
| 1 μm averaged | 21.94 | 18.7 | 15.01 | 10.3 | 7.466 |
| 4 μm averaged | 8.744 | 7.504 | 6.284 | 4.45 | 3.31 |
| 20 μm averaged | 2.078 | 1.624 | 1.416 | 1.02 | 0.826 |

TABLE 3

| Indentation Depth (μm) | 1 | 4 | 12 | 20 | 50 |
|---|---|---|---|---|---|
| (a) | | | | | |
| 200° C. HU R = | 0.93 | 0.92 | | 0.88 | No Data |
| | | | | | up to 20 μm |
| (b) | | | | | |
| Room Temperature HU R = | 0.76 | 0.79 | | 0.79 | No Data |
| | | | | | up to 20 μm |

What is claimed is:

1. A method for evaluating a fixing member used to fix toner, said fixing member being produced by sequentially coating an elastic layer and a separation layer onto a base element, comprising:
carrying out the universal hardness test for each of first and second indentation depths from the surface side of said separation layer, wherein
when the universal hardness for each of said first and second indentation depths is in a predetermined value, said fixing member is regarded as a standard product.

2. A method for evaluating a fixing member used to fix toner, said fixing member being produced by sequentially coating an elastic layer and a separation layer onto a base element, comprising:
carrying out the universal hardness test for each of indentation depths of 1 μm and 4 μm from the surface side of said separation layer, wherein
when the universal hardness HU for the indentation depth of 1 μm satisfies a relation,
HU≦30 [N/mm²],
and, when the universal hardness HU for the indentation depth of 4 μm satisfies a relation,
HU≦12 [N/mm²],
said fixing member is regarded as a standard product.

3. A method for evaluating a fixing member as claimed in claim 1 or 2, wherein said universal hardness test is carried out at a test environment temperature of 25° C.

4. A method for evaluating a fixing member used to fix toner, said fixing member being produced by sequentially coating an elastic layer and a separation layer onto a base element, wherein the universal hardness test is carried out at a test environment temperature of 200° C. for each of indentation depths of 1 μm and 4 μm from the surface side of said separation layer,
when the universal hardness HU for the indentation depth of 1 μm satisfies a relation,
HU≦10 [N/mm²],
and, when the universal hardness HU for the indentation depth of 4 μm satisfies a relation,
HU≦4 [N/mm²],
said fixing member is regarded as a standard product.

5. A method for evaluating a fixing member as claimed in claim 1, 2, 3 or 4, wherein said elastic layer is made of silicone gum.

6. A method for evaluating a fixing member as claimed in claim 1, 2, 3 or 4, wherein said separation layer is made of a material including at least one of polytetrafluoroethylene (PTFE) resin, polytetrafluoroethylene-perfluoro-alkoxyl (PFA) vinyl ether copolymer resin, and polytetrafluoroethylene-fluorinated ethylene propylene (FEP) copolymer resin.

7. A method for evaluating a fixing member as claimed in claim 1, 2, 3 or 4, wherein said fixing member is a fixing belt.

8. A method for evaluating a fixing member as claimed in claim 1, 2, 3 or 4, wherein said fixing member is a thermal fixing roller.

9. A fixing belt formed by sequentially coating an elastic layer and a separation layer onto a base element, wherein, when the measurement is carried out at a test environment temperature of 25° C.,
the universal hardness HU for an indentation depth of 1 μm from the surface side of said separation layer satisfies the relation,
HU≦30 [N/mm²],
and the universal hardness HU for an indentation depth of 4 μm satisfies the relation,
HU≦12 [N/mm²].

10. A fixing belt formed by sequentially coating an elastic layer and a separation layer onto a base element, wherein,
when the measurement is carried out at a test environment temperature of 200° C.,
the universal hardness HU for an indentation depth of 1 μm from the surface side of said separation layer satisfies the relation,
HU≦10 [N/mm²],
and the universal hardness HU for an indentation depth of 4 μm satisfies the relation,
HU≦4 [N/mm²].

11. A fixing belt as claimed in claim 9 or 10, wherein said elastic layer is made of silicone gum.

12. A fixing belt according to claim 9 or 10, wherein said separation layer is made of a material including at least one of polytetrafluoroethylene (PTFE) resin, polytetrafluoroethylene-perfluoro-alkoxyl (PFA) vinyl ether copolymer resin, and polytetrafluoroethylene-fluorinated ethylene propylene (FEP) copolymer resin.

13. A thermal fixing roller formed by sequentially coating an elastic layer and a separation layer onto a base element, wherein,
when the measurement is carried out at a test environment temperature of 25° C.,
the universal hardness HU for an indentation depth of 1 μm from the surface side of said separation layer satisfies the relation,
HU≦30 [N/mm²],
and the universal hardness HU for an indentation depth of 4 μm satisfies the relation,
HU≦12 [N/mm²].

14. A thermal fixing roller formed by sequentially coating an elastic layer and a separation layer onto a base element, wherein,
when the measurement is carried out at a test environment temperature of 200° C.,
the universal hardness HU for an indentation depth of 1 μm from the surface side of said separation layer satisfies the relation,
HU≦10 [N/mm²],
and the universal hardness HU for an indentation depth of 4 μm satisfies the relation,
HU≦4 [N/mm²].

15. A thermal fixing roller as claimed in claim 13 or 14, wherein said elastic layer is made of silicone gum.

16. A thermal fixing roller as claimed in claim 13 or 14, wherein said separation layer is made of a material including at least of polytetrafluoroethylene (PTFE) resin, polytetrafluoroethylene-perfluoro-alkoxyl (PFA) vinyl ether copolymer resin, and polytetrafluoroethylene-fluorinated ethylene propylene (FEP) copolymer resin.

17. A thermal fixing apparatus including a fixing belt as claimed in claim 9 or 10.

18. A thermal fixing apparatus including a thermal fixing roller as claimed in claim 13 or 14.

19. An image forming apparatus including a fixing belt as claimed in claim 9 or 10.

20. An image forming apparatus including a thermal fixing roller as claimed in claim 13 or 14.
